(19) United States
(12) Patent Application Publication
(10) Pub. No.: US 2013/0080513 A1
(43) Pub. Date: Mar. 28, 2013

(54) MULTI-PARTY COMMUNICATION SESSIONS VIA BROADCAST NOTIFICATION NETWORK

(71) Applicant: Jeremy Debate, Boston, MA (US)

(72) Inventor: Jeremy Debate, Boston, MA (US)

(21) Appl. No.: 13/627,447

(22) Filed: Sep. 26, 2012

Related U.S. Application Data
(60) Provisional application No. 61/540,218, filed on Sep. 28, 2011.

(51) Int. Cl. G06F 15/16

(52) U.S. Cl. 709/203

(57) ABSTRACT

According to example configurations, a first server in network registers a first client as a participant in a communication session. In response to receiving a message posted by the first client to the communication session, the first server initiates broadcast of a notification of receiving the message to other servers in the network. A second server in the network receives the broadcast notification at a second server in the network. In response to receiving the broadcast notification at the second server and identifying that a second client is registered as a participant in the communication session, the second server notifies the second client of the message posted by the first client. Thus, a broadcast or multicast network can be configured to support targeted communications between multiple participants in a communication session.

### RELATED APPLICATIONS

This application is related to and claims the benefit of earlier filed U.S. Provisional Patent Application Ser. No. 61/540,218 entitled “MULTI-PARTY COMMUNICATION SESSIONS VIA BROADCAST NOTIFICATION NETWORK,” (Attorney Docket No. APP11-02p), filed on Sep. 28, 2011, the entire teachings of which are incorporated herein by this reference.

### BACKGROUND

One way to provide synchronous communications amongst a group of multiple remote participants is to configure a server in a network to be a common point in a conventional collaboration application. In such an application, multiple clients initially join a collaborative session via a respective browser. In general, the server receives communications from each of multiple parties and conveys the received information to the different participants in communication with the server.

As an example, each of the clients can be a participant in a whiteboard application in which edits to the whiteboard by each are transmitted to the collaboration application on the server. The server initiates distribution of the edits to each of the participants in the whiteboard session. Accordingly, each participant in the whiteboard session can be notified of the modifications made by other members.

Other conventional applications such as web-based chat applications (e.g., Facebook™ chat, Twitter, etc.) support communication of messages amongst participants. In accordance with such applications, the client polls a respective server to retrieve message information.

### BRIEF DESCRIPTION

Use of the conventional techniques to support communications as discussed above suffers from deficiencies. For example, many collaborative software applications enable participants to collaborate with each other over a network via an application such as a web browser. However, such applications do not scale well. For example, a single server supporting a collaboration session may become inundated with too many clients and fail to provide support for a dynamic environment in which the number of users increases over time. Another example are conventional applications that support polling of messages. Polling for messages typically wastes network resources, battery power, etc., because a new connection must be created to send or retrieve posted messages, which incurs significant overhead.

Embodiments herein deviate with respect to conventional techniques. For example, one embodiment herein includes a novel technique of providing private communications amongst a group of participants in a communication session via broadcasting of notification messages in a network and, thereafter, forwarding notification of the messages to clients. In one embodiment, the notification network supports substantially real-time transmission of messages to others without requiring the respective client sending the message from having to receive confirmation that any other participants in the network have received the message.

More specifically, in accordance with one embodiment, a notification network includes multiple servers or access points in a message notification system. Each of the servers can include a registry indicating one or more participants that join the communication session via a respective link from a client to the server in the network. In one embodiment, the servers communicate with each other via broadcasting of messages to other servers in the network regardless of whether a respective server in the network has any clients registered to participate in the communication session. The servers that receive the messages broadcasted in the network provide notifications to the clients participating in a respective communication session.

As an example, assume that a first server in the notification network registers a first client as a participant in a communication session. Subsequent to being registered as a participant and establishing a link between the first client and the server, the first client is able to post messages to other participants (if any) that are registered as participants in that same communication session.

For example, in response to receiving a message posted by the first client to the communication session, the first server generates a notification of receiving the message. In one embodiment, the first server initiates a broadcast of the notification to multiple other servers (e.g., a second server, a third server, etc.) that are part of the network even though it is not known whether any of the other servers (to which the notification is broadcasted) have any clients that are registered as participants of the specific communication session. Thus, according to embodiments herein, a respective server or access point receiving a posted message from a member initiates transmission of the broadcast notification to a group of servers in the network regardless of whether any other server in the group to which the notification has been broadcasted has any clients registered with the communication session.

Further assume in this example that a second server of the multiple servers receives the broadcast notification from the first server. That is, the second server is one of the other servers in the network receiving the broadcast notification initiated by the first server. In response to receiving the broadcast notification at the second server and identifying that a second client happens to be registered as a participant in the communication session to which the message is posted, the second server notifies the second client of the message posted by the first client.

In a similar manner, each of the servers in the network that receives the broadcast notification in the network checks if the server has any clients that are registered as participants in the communication session. If so, the respective server notifies the registered participants of the message posted by the first client. Notification to the participants of the communication session can include transmitting all or a portion of the contents of the original message posted by the first client to the communication session.

In accordance with yet further embodiments, note that forwarding contents and/or providing notification of messages from a server to a corresponding client can be conditional. For example, as previously discussed, a respective client operating an application can register with a server as to become a participant in a communication session. In such an embodiment, the registering server can receive rules indicating conditions in which the registering server is to forward messages and/or notifications to the respective client. For example, each respective client can provide their configuration setting information to the server indicating what types of messages posted by other clients to the communication session will be forwarded to the respective client. Accordingly, the registering server can control or filter which messages are forwarded to the respective client in accordance with configuration settings provided by the respective client.

Note that the second client as discussed in the above example can also post messages to the communication session. In response to receiving a message posted by the second client to the communication session via a communication to the second server, the second server initiates broadcasting of a corresponding notification of receiving the message posted by the second client to other servers in the network. In response to the first server in the network receiving the broadcast notification of the message posted by the second client, the first server notifies the first client of the message (or portion thereof) posted by the second client. Accordingly, the communication system as discussed herein supports targeted bi-directional communications via use of a broadcast network.

As discussed herein, each of multiple participants in a communication session can be notified of messages posted by another participant without requiring the clients or servers to setup and maintain a dedicated communication link for a respective communication session. That is, instead of requiring creation of dedicated links between clients to convey communications amongst participants, servers in the network receive broadcast messages indicating when a client of a particular communication session has posted a message. The servers receiving the broadcasted notification then check their respective register to identify whether any of their registered clients are participants of the communication session to which the message was posted. If so, the registered participants are notified as discussed herein that another participant of the communication posted a message. Accordingly, there is no need for clients to be in direct communication with each other as in conventional methods.

A server or access point as discussed herein can register a client at least in part in response to the client executing an application to which the communication session pertains. For example, each of one or more of the multiple mobile devices can be configured to execute a common application. In response to executing the common application at a respective mobile device, the user of the mobile device can be queried whether they would like to join a respective communication session associated with the application. If so, the client (e.g., application in the mobile device) transmits a message to the server (e.g., the server to which it is registered) indicating that the user would like to post messages or receive any posting of messages by other clients (e.g., users of other mobile devices) to the communication session. The registered clients receive notification of the postings as discussed above.

Registration of the clients with a server in the notification network can include establishing a persistent bi-directional communication link between a respective client and server in the notification network. A respective persistent bi-directional link between a client and the server can be open or active as long as the client executes a respective application at the mobile device and/or until the client initiates a message to the server to exit the communication session. As mentioned, a client is able to post a message over the link to the communication session; the client also can be notified of messages posted by other participants over the link.

In one embodiment, the persistent communication link is based on use of an HTML 5 web socket. Most corporate firewalls enable communications on such resources. Via the persistent communication link, applications executed on the mobile devices and registered with a respective communication session can send and receive information to other participants without the hindrance of the firewall.

Each persistent link between a client and server or between a server and another server in the network can be configured to support encrypted communications. The communication link or port can remain open or active even though a participant of the communication session does not send or receive messages or notifications.

In one embodiment, each of the clients can execute a particular application on a respective mobile device. For example, the particular application can be distributed to employees in an organization; each of the employees operates their own mobile device. The application, when executed by a respective user on a mobile device, can enable registration with a server in the network to participate in the communication session. As discussed herein, the participant to the communication session can post and receive messages.

As mentioned, each of the servers in the network can support one or more connections with clients. In response to detecting a condition such as that a number of clients registering to participate in a respective communication session exceeds a threshold value, additional servers can be assigned to the network to receive broadcast type messages and support communications with additional clients that would like to register as participants in the communication session. Accordingly, the notification network as discussed herein can be expanded to accommodate additional participants as needed. That is, a newly added server can support connections with one or more clients. The newly added server receives broadcast notifications from and transmits broadcast notifications to other servers in the notification network as previously discussed.

Note that a client coupling to a server in the broadcast network can be any type of resource. For example, in one embodiment, a client requesting to be a participant in the communication session is a corporate server (e.g., server external to the notification network). In such an embodiment, a given server in the notification network registers the corporate server as a participant in the communication session. The given server communicates with the corporate server via a dedicated communication link in a manner as previously discussed. The corporate server can receive notification of one or more messages posted by other participants to the communication session as well as post messages to other participants in the communication session via the dedicated link between the corporate server and the server in the notification network.

Embodiments herein are useful over conventional techniques. For example, one conventional technique requires that a respective client poll a server to retrieve messages. Polling can include setting up a temporary web connection with a server each time the client checks for available messages from a server. In contrast, the notification system and related techniques as discussed herein enables a client to set up a persistent link on which to receive messages from the server without having to repeatedly set up and tear down a web connection. Additionally, the persistent link enables clients to send and receive messages on an encrypted and dedicated communication link without the hindrance of a corporate firewall. That is, most firewalls block many communications but typically enable one to make HTTP requests and setup HTTP type connections.

As discussed above, techniques herein are well suited for use in communication systems supporting communications amongst participants in a communication session. However, it should be noted that embodiments herein are not limited to use in such applications and that the techniques discussed herein are well suited for other applications as well.

These and other embodiments are discussed in more detail below.

As mentioned above, note that embodiments herein can include a configuration of one or more computerized devices, workstations, handheld or laptop computers, or the like to carry out and/or support any or all of the method operations disclosed herein. In other words, one or more computerized devices or processors can be programmed and/or configured to operate as explained herein to carry out different embodiments of the invention.

Yet other embodiments herein include software programs to perform the steps and operations summarized above and disclosed in detail below. One such embodiment comprises a computer program product including a non-transitory computer-readable storage medium (i.e., any suitable computer readable hardware storage medium) on which software instructions are encoded for subsequent execution. The instructions, when executed in a computerized device having a processor, program and/or cause the processor to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, etc., or other a medium such as firmware or microcode in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, one particular embodiment of the present disclosure is directed to a method and computer program product that includes a computer readable hardware storage medium having instructions stored thereon for supporting bi-directional communications. For example, in one embodiment, the instructions, when executed by a processor of a respective computer device, cause the processor to: register a first client as a participant in a communication session; in response to receiving a message posted by the first client to the communication session, initiate broadcast notification of receiving the message from a first server that receives the message to other servers in a network; receive the broadcast notification at a second server in the network, the second server being one of the other servers in the network receiving the broadcast notification initiated by the first server; and in response to receiving the broadcast notification at the second server and identifying that a second client is registered as a participant in the communication session, notify the second client of the message posted by the first client.

Another embodiment herein is directed to a method and computer program product that includes a computer readable storage medium having instructions stored thereon for supporting novel communications. For example, in one embodiment, the instructions, when executed by a processor of a respective computer device, cause the processor to: at a first server in a network in which servers communicate via transmission of broadcast-type messages, receive a message from a first client over a communication link between the first client and the first server; in response to receiving the message at the first server, initiate broadcast of the message from the first server to other servers in the network; receive the broadcasted message at a second server in the network, the second server being one of the other servers receiving the broadcasted message; and from the second server, notify a second client of the broadcasted message over a communication link between the second server and the second client.

The ordering of the steps has been added for clarity sake. These steps can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein can be embodied strictly as a software program, as a hybrid of software and hardware, or as hardware alone such as within a processor, or within an operating system or a within a software application.

Additionally, although each of the different features, techniques, configurations, etc., herein may be discussed in different places of this disclosure, it is intended that each of the concepts can be executed independently of each other or, where suitable, the concepts can be used in combination with each other. Accordingly, the one or more present inventions as described herein can be embodied and viewed in many different ways.

Also, note that this preliminary discussion of embodiments herein does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), and additional points of novelty, the reader is directed to the Detailed Description section and corresponding figures of the present disclosure as further discussed below.

### BRIEF DESCRIPTION OF THE DRAWINGS

FIG. 1 is an example diagram of a communication system including a notification network and respective clients according to embodiments herein.

FIG. 2 is an example diagram illustrating client registration and configuration information according to embodiments herein.

FIG. 3 is an example diagram illustrating a communication system according to embodiments herein.

FIG. 4 is an example diagram illustrating the directory of all clients attached to a specific server according to embodiments herein.

FIG. 5 is an example diagram illustrating use of forwarding rules according to embodiments herein.

FIG. 6 is an example diagram illustrating an example computer architecture for implementing functionality according to embodiments herein.

FIG. 7 is a flowchart illustrating an example method of supporting one or more communication sessions via use of a broadcast network such as a virtual notification network according to embodiments herein.

FIGS. 8 and 9 combine to form a flowchart illustrating an example method of supporting one or more communication sessions via use of a broadcast network according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

According to one example embodiment, a first server in network registers a first client as a participant in a communication session. In response to receiving a message posted by the first client to the communication session, the first server initiates broadcast of a notification of receiving the message to other servers in the network that form part of a respective virtual notification network. A second server in the network receives the broadcast notification. In response to receiving the broadcast notification at the second server and identifying that a second client is registered as a participant in the communication session to which the message was posted by the first client, the second server notifies the second client of the message posted by the first client. Thus, a broadcast or multicast network can be configured to support targeted communications between multiple participants in a communication session.

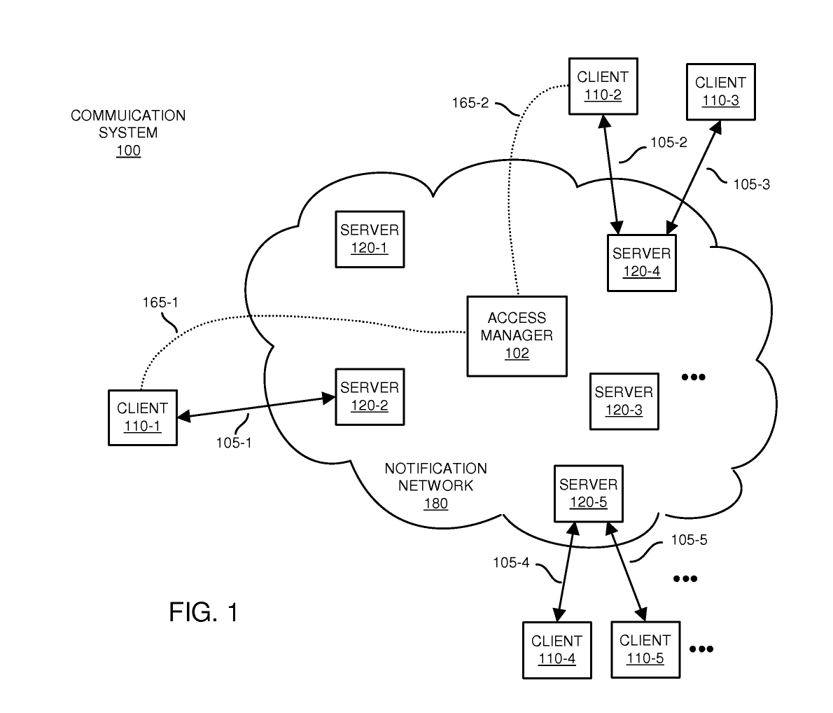

More specifically, FIG. 1 is an example diagram of a communication system including a notification network and respective clients according to embodiments herein.

In accordance with one embodiment, notification network 180 includes multiple servers 120 (e.g., server 120-1, server 120-2, server 120-3, server 120-4, server 120-5, . . . ). Each of the servers 120 is an access point in network 180 enabling a respective client to join one or more communication sessions.

By way of a non-limiting example, any of one or more the clients 110 can be a mobile device such as a cell phone, personal digital assistant, portable computer device, iPhone™, iPad™, etc. Thus, notification network 180 and respective servers support communications with multiple different types of platforms. Each communication link 105 can be a wireless communication link between a client and respective server.

Additionally, note that any of one or more of the clients can be coupled to communicate with the notification network 180 via a hardwired link such as a cable modem, telephone line, network cable, etc.

In one embodiment, to join a respective communication session or open a new communication session, a respective client in communication system 100 initially communicates with access manager 102. For example, a user operating a respective client can initiate execution of a particular application on their client device. The executed application can be configured to include an address with which to communicate with the access manager 102. Upon executing the application at the client, the application provides the option to the user to create or join a communication session supported by notification network 180. If the client would like to join a communication session, the client communicates a connection request to the access manager 102 at the provided address. The access manager 102 processes the connection request and checks one or more parameters such as a current load conditions of network 180 to determine which server, if any, in notification network 180 is suited to maintain a connection with the requesting client.

In response to the connection request, the access manager 102 notifies the requesting client of an appropriate access point (e.g., server) in notification network 180. Notification from the access manager 102 to the client of a respective access point can include providing the requesting client with an address of a server that is to be used by the client to join one or more communication sessions.

Note that each of a group of one or more servers 120 in the notification network 180 can support one or more connections with respective clients.

The access manager 102 can keep track of parameters such as how many clients are participants in a respective communication session or established communication channel, how many communication links 105 have been established with each server, etc. Based on these load conditions, the access manager 102 can control configuration of notification network 180. For example, in response to detecting a condition such as that a number of clients registering to participate in a respective communication session exceeds a threshold value, additional servers can be assigned to the network (e.g., a virtual notification center of servers) to receive broadcast type messages and support communications with additional clients that would like to register as participants in the communication session.

In response to detecting a condition such as that a number of clients registered with a particular server 120 in notification network 180 is above a threshold value, the access manager 102 can provide a different server address to future requestors such that any single server is not overloaded with maintaining too many communication links with respective clients. Accordingly, the virtual notification center (e.g., group of servers 120) as discussed herein can be expanded or reduced to accommodate an addition or reduction of participants on an as-needed basis.

Subsequent to making a request and receiving address information from access manager 102, the requesting client then utilizes the address information received from the access manager 102 to establish a communication link 105 with the identified server. For example, assume in this example that client 110-1 receives an address to server 120-2 in response to requesting to join a particular communication session or channel. The client 110-1 utilizes the received address to communicate with server 120-2 to set up respective communication link 105-1 between the client 110-1 and server 120-2. In one embodiment, the client 110-1 requests to join a communication session pertaining to the application executed by the client 110-1 although the client 110-1 can join any communication session as permitted by the server 120-2.

Each of the clients can execute a particular application on a respective mobile device. For example, the particular application can be distributed to employees in an organization; each of the employees operates their own mobile device. The application, when executed by a respective user on a mobile device or client, enables registration with a respective server 120 in the notification network 180 as discussed above. The communication session can be based on the type of application executed by the client. For example, clients executing a same type of application can become participants of a particular communication session supported by the type of application. In accordance with such an embodiment, subsequent to receiving a broadcasted message generated by an application executed on a client, a server broadcasts a notification of the received message in notification network 180. Servers process the broadcasted message to identify a type of application that generated the message. In response to detecting that one or more clients are registered to receive messages from clients executing the type of application executed by the client, the servers initiate transmission of the broadcasted message to the one or more clients also executing the application.

In a similar manner, each of other clients executing the same application as client 110-1 in communication system 100 request to join the same communication session based on executing the same application as client 110-1. For example, assume in this example that client 110-2 also communicates with access manager 102 to join one or more communication sessions. Client 110-2 receives an address from the access manager 102. The received address indicates a server in which to communicate and join the respective communication session.

The client 110-2 uses the received address to communicate with an appropriate access point (e.g., server) in notification network 180 and set up a communication link. More specifically, assume in this example that client 110-2 receives an address to server 120-4 in response to requesting to join a particular communication session. The client 110-2 communicates with server 120-4 to set up a respective communication link 105-2 between the client 110-2 and server 120-4.

In one embodiment, each of the communication links 105 can be persistent. That is, the communication links 105 can remain open or active even though no communications are sent over the link for some time. In one embodiment, the communication links 105 can be created based on use of an HTTP (HyperText Transfer Protocol) or any other suitable protocol. For example, via use of the HTML 5 web socket (e.g., via an upgrade header in which value=websocket), the client can establish a connection between endpoints on which to transmit and receive raw data such as Transmission Control Protocol/Internet Protocol data.

Note that the connectivity between a each respective server in notification network 180 and another server in notification network can be based on the same type of connection as communication links 105. Links between the servers can be persistent type of bi-directional links enabling broadcasting of messages as discussed herein such that a notification message is broadcasted to each member server in a respective virtual notification network.

In accordance with further embodiments, each of the clients executes a respective daemon process to manage communications to and from the respective server to which the client is coupled via a communication link 105, unless such communications are handled by the main process in the client device. For example, the daemon operating in a respective client device (e.g., mobile device) transmits messages received from a respective application on the client over the communication link to the server. The daemon also can receive messages from the respective server over the communication link.

Via the persistency of communication links 105, applications executed on the clients such as mobile devices can send and receive information to other participants of a communication session (e.g., named channel) without the hindrance of communicating through a firewall.

Each communication link 105 between a respective client and server (or between a server in notification network 180 and a server external to notification network 180) can be configured to support encrypted communications. The communication links or ports can remain open or active even though a participant of the communication session does not send or receive messages or notifications associated with a communication session.

As will be discussed later in this specification, notification network 180 supports communications between clients 110 in communication system 100 via broadcasting of notification messages amongst server 120. The original message posted by a client or portion thereof can be included in the notification message broadcasted to other servers.

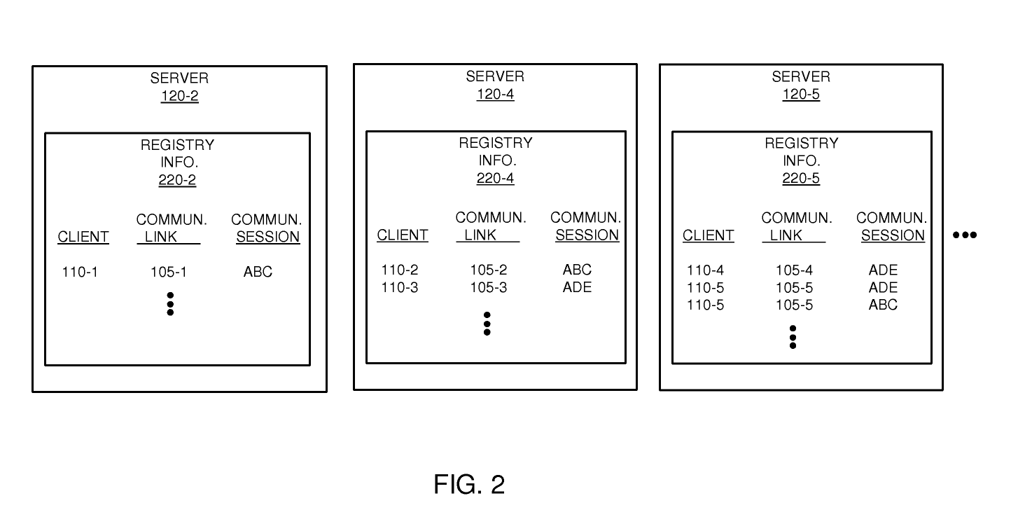

FIG. 2 is an example diagram illustrating registry information maintained by one or more servers according to embodiments herein.

As previously discussed, a communication link 105 between each client and server enables communication of messages in either direction. Each server 120 can maintain respective registry information 220 about the communication sessions, links, etc. For example, registry information 220-2 indicates that client 110-1 has requested and joined communication session ABC. Registry information 220-2 further indicates that communication link 105-1 provides connectivity between client 110-1 and server 120-2.

Registry information 220-4 associated with server 120-4 indicates that client 110-2 has also joined communication session ABC and that communication link 105-2 provides connectivity between client 110-2 and server 120-4. Registry information 220-4 also indicates that client 110-3 has joined communication session ADE and that communication link 105-3 provides connectivity between client 110-3 and server 120-4.

Registry information 220-5 associated with server 120-5 indicates that client 110-4 has also joined communication session ADE and that communication link 105-4 provides connectivity between client 110-4 and server 120-5; registry information 220-5 also indicates that client 110-5 has joined communication session ADE and that communication link 105-5 provides connectivity between client 110-5 and server 120-5; and so on.

Note that a single communication link 105 can provide support for participating in multiple communication sessions. For example, as indicated by registry information 220-5, communication link 105-5 also enables client 110-5 to participate in communication session ABC and communication session ADE.

A server or access point in notification network 180 as discussed herein can register a client as a participant based at least in part in response to the client executing an application to which the communication session pertains. For example, each of multiple mobile devices can be configured to execute a common application as previously discussed.

In response to executing the common application at the respective mobile device, the user of the mobile device can be queried whether they would like to join a respective communication session associated with the application. If so, the client (e.g., application in the mobile device) transmits a message to the server (e.g., the server to which it is registered) indicating that the user would like to receive any posting of messages by other clients (e.g., users of other mobile devices) to the communication session.

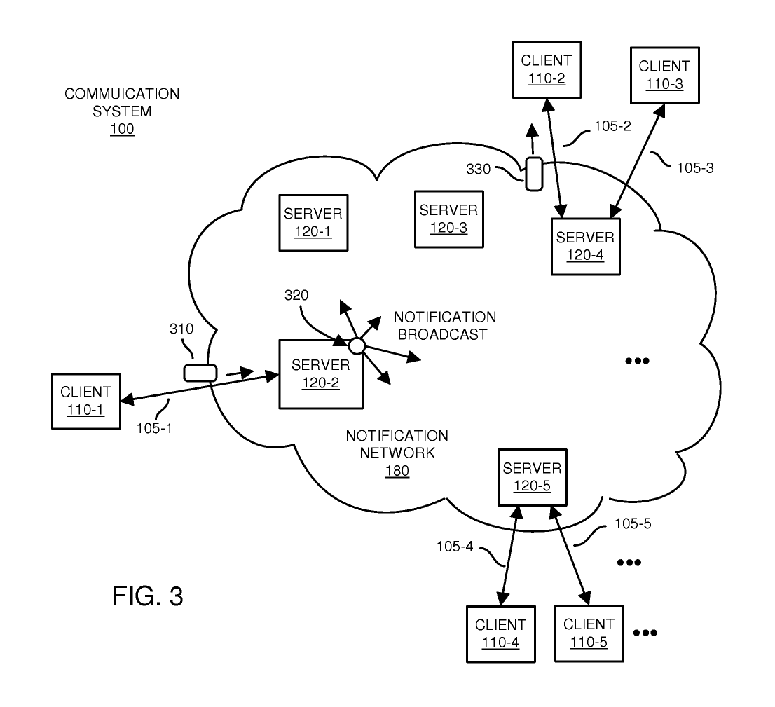

FIG. 3 is an example diagram illustrating how clients communicate with each other as participants in a communication session via transmission of broadcast-type messages amongst servers in notification network according to embodiments herein.

As previously discussed, each of the servers 120 maintains registry information 220 indicating clients 110 that have joined as participants in the different communications sessions (e.g., communication session ABC, ADE, etc.).

In one embodiment, the servers 120 communicate with each other via broadcasting or multi-casting of notification messages to other servers 120 in the notification network 180 regardless of whether a respective server in the notification network 180 has any clients registered to participate in the communication session. The servers and/or clients need not be burdened with whether or not appropriate participants receive the notification and/or messages. The servers 120 receive the messages broadcasted in the network and provide notifications to the clients participating in a respective communication session.

As previously discussed, assume that server 120-2 in the notification network 180 registers client 110-1 as a participant in communication session ABC. Subsequent to being registered as a participant to communication session ABC and establishing a communication link 105-1 between the client 110-1 and the server 120-2, the client 110-1 is able to post messages to other participants (e.g., clients), if any, that are also registered as participants in the communication session ABC. In one embodiment, server 120-2 does not have knowledge of whether any other severs in notification network 180 have respective communication links to clients that are participants of communication session ABC.

In this example, assume that an application executed on the client 110-1 posts a message 310 to the communication session or channel named ABC. In such an instance, the daemon in client 110-1 receives the generated message (or generates the message as the case may be) and forwards the message 310 over communication link 105-1 to server 120-2. Note that the message 310 can be encoded to include a channel name or communication session to which the message 310 is directed.

In response to receiving the message 310 posted by the client 105-1 to the communication session ABC, the first server 120-2 generates a notification 320 of receiving the message 310. The notification 320 can include none, some, or all of the contents or data in message 310. Additionally, the notification 320 can be encoded to include a channel name or communication session to which the post is originally directed.

In accordance with one embodiment, the notification message 320 includes information such as an identifier value or channel name of a communication session to which the notification 320 pertains and/or a message data retrieved from the original message 310 provided by client 110-1. Accordingly, a respective server in notification network 180 receiving the notification 320 can check the identifier value in the notification 320 and forward appropriate data (e.g., all or part of the original message 310) in the notification 320 to appropriate participants of the communication session. As will be discussed later in this specification, the servers receiving the notification 320 can selectively forward all or part of the message based on forwarding rules.

In this example, the server 120-2 receiving the posted message 310 initiates a broadcast of the notification 320 to each of multiple other servers (e.g., server 120-1, server 120-3, server 120-4, . . . ) in notification network 180 even though it is not known whether any of the other servers (to which the notification is broadcasted) have any clients that are registered as participants of the communication session ABC.

Note that any suitable protocol can be used to broadcast the notification 320 to other servers in notification network 180. For example, in one embodiment, the server 120-2 transmits the message to each server in notification network 180. In accordance with another embodiment, the server 120-2 can forward the notification 320 to another resource such as access manager 102 that, in turn, broadcasts the notification 320 to each server. In yet another embodiment, the server 120-2 can forward the notification 320 to one or more resources such as servers, routers, etc., that, in turn, support broadcast or multicast of notification 320 such that all servers in notification network 180 are notified.

In this example, the server 120-4 receives the broadcast notification 320. That is, the server 120-4 is one of the other servers in the notification network 180 that receives the broadcast notification 320 initiated by the server 120-2. In response to receiving the broadcast notification 320 at the server 120-2 and identifying that client 110-2 happens to be registered as a participant in the communication session ABC to which the message 310 was directed, the server 120-4 notifies the client 110-2 of the message 310 (and all or a portion of contents thereof) as posted by the client 110-1. In response to detecting that client 110-3 is not registered with the server 120-4 to receive messages from clients executing the type of application executed by the first client (or that the client is not a member of a respective communication session ABC), the server 120-4 prevents transmission of the broadcasted notification 320 or contents of message 310 to the client 110-3.

In a similar manner, each of the servers 120 in the notification network 180 that receives the broadcasted notification 320 checks if the respective receiving server has any clients that are registered as participants in the communication session (e.g., ABC) to which the notification 320 pertains. If so, the respective server notifies the registered participants of the message posted by the first client. Thus, client 110-5 also receives at least a notification of message 310 posted by the client 110-1. As mentioned, providing notification to the participants of the communication session can include transmitting all or a portion of the contents of the original message 310 posted by the client 110-1.

Additionally, note that the client 110-2 can also post messages to the communication session ABC. For example, in response to receiving a message posted by the client 110-2 to the communication session via a communication between the client 110-2 and the server 120-4, the server 120-4 initiates broadcasting a notification of receiving the message posted by the client 110-2 to other servers in the notification network 180. In response to the server 110-1 in the network receiving the broadcast notification of the message posted by the client 110-2, the server 120-1 notifies the client 110-1 of the message posted by client 110-2. In response to the server 110-5 in the network receiving the broadcast notification of the message posted by the client 110-2, the server 120-5 notifies the client 110-5 of the message posted by client 110-2, and so on. Accordingly, the communication system 100 as discussed herein supports targeted bi-directional communications via use of a broadcast network (e.g., notification network 180).

Each of multiple participants in a respective communication session can be notified of messages posted by another participant without requiring the clients or servers to setup and maintain a dedicated communication link for a respective communication session. That is, instead of requiring creation of dedicated links between clients to convey communications amongst participants in a communication session, servers 120 in the notification network 180 receive broadcast messages indicating when a participant of a particular communication session has posted a message. The servers receiving the broadcasted notification then check their respective registry information 220 to identify whether any of their registered clients are participants of the communication session to which the message was posted. If so, the registered participants are notified as discussed herein that another participant of the communication posted a message. Accordingly, there is no need for clients to be in direct communication with each other as in conventional methods.

Embodiments herein are useful over conventional techniques. For example, certain conventional techniques require that a respective client poll a server to retrieve messages associated with a collaborative session. Conventional polling can include sending appropriate messages to set up a temporary web connection with a server each time the client checks for available messages from the server. In contrast to conventional techniques, the notification system and related techniques as discussed herein enables each of one or more clients to set up a persistent bi-directional link on which to receive and transmit messages from the server without having to repeatedly set up and tear down connections. Additionally, the persistent link enables clients to send and receive messages without the hindrance of a corporate firewall.

As discussed herein, a group of servers 120 (e.g., which can be considered a virtual notification center) can be a single message notification center that supports posting of notifications to a corresponding set of clients 110. Note that notification network 180 can include any number of virtual notification centers (e.g., groupings of servers in a respective virtual broadcast network). Each so-called virtual notification center can be configured to support notifications to employee clients of a respective company via secured, HTTP type connections. Accordingly, employee clients in a respective company can communicate with one another without the messages being posted to unauthorized parties. Note again that communications amongst client participants within a company and respective virtual network also can be secured from each other.

As previously discussed, the clients 110 can be different kinds of devices supporting different platforms. Thus, one embodiment herein includes a cross-platform notification system in which different types of clients are notified of posted messages. In one embodiment, notification network 180 is a virtual private network of multiple servers that collectively provide services to one or more private companies and their employees. For example, clients joining as participants in a respective communication session can be employees of a same company executing a particular type of application on their mobile devices. For example, one embodiment herein includes configuring each client with a location-tracking device such as a GPS (Global Positioning System). Each respective client at least occasionally transmits or posts a message including respective location information of the respective client to the communication session via their respective persistent link with a server. Accordingly, each participant of a communication session or a monitor application that participates in the communication session can be aware of the current location of each participant at any time.

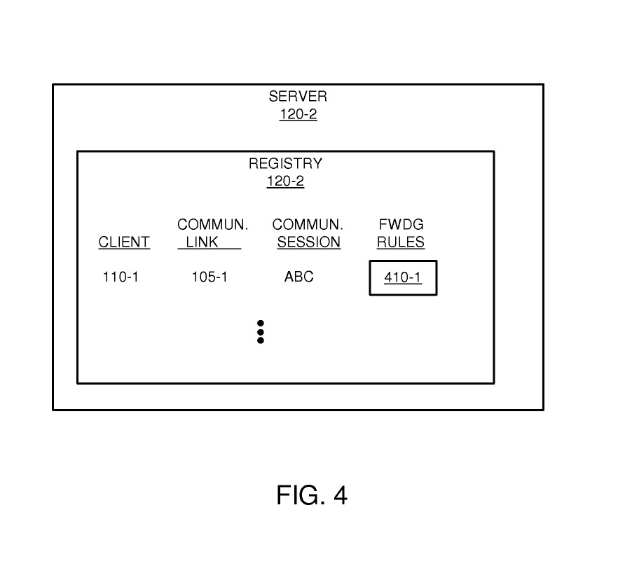

FIG. 4 is an example diagram illustrating tracking of message handling rules for each of multiple clients according to embodiments herein.

As shown, in addition to maintaining information such as a client identifier information, communication link information, communication session information, etc., as previously discussed, the registry information 220 for a respective server can further include message handling rules indicating how to handle forwarding of messages for a particular client or a group of clients.

For example, in one embodiment, the handling information for a respective client indicates what type of information in a message from another participant will be forwarded to the client. Accordingly, a client registering with a server as a participant of a communication session may be configured to receive only desired types of information from other participants. As an example, client 110-1 may post a message 310 to communication session ABC. The message posted by client 110-1 may include X-type, Y-type data, and Z-type data.

Message handling settings (i.e., forwarding rules 410-1 provided by client 110-2 to server 120-4 can indicate that client 110-2 would like to receive only Y-type data but not X-type data and Z-type data for any transmitted messages. Upon receiving the notification 320 posted to communication session ABC, the server 120-4 checks forwarding information associated with client 110-2 and forwards only the Y-type data in message 310 to client 110-2. Each of the clients can control forwarding of information in a similar manner.

In a similar manner, the respective forwarding rules can place restrictions as to the types of information that are to be made available by each of the servers to the different clients for a respective communication session.

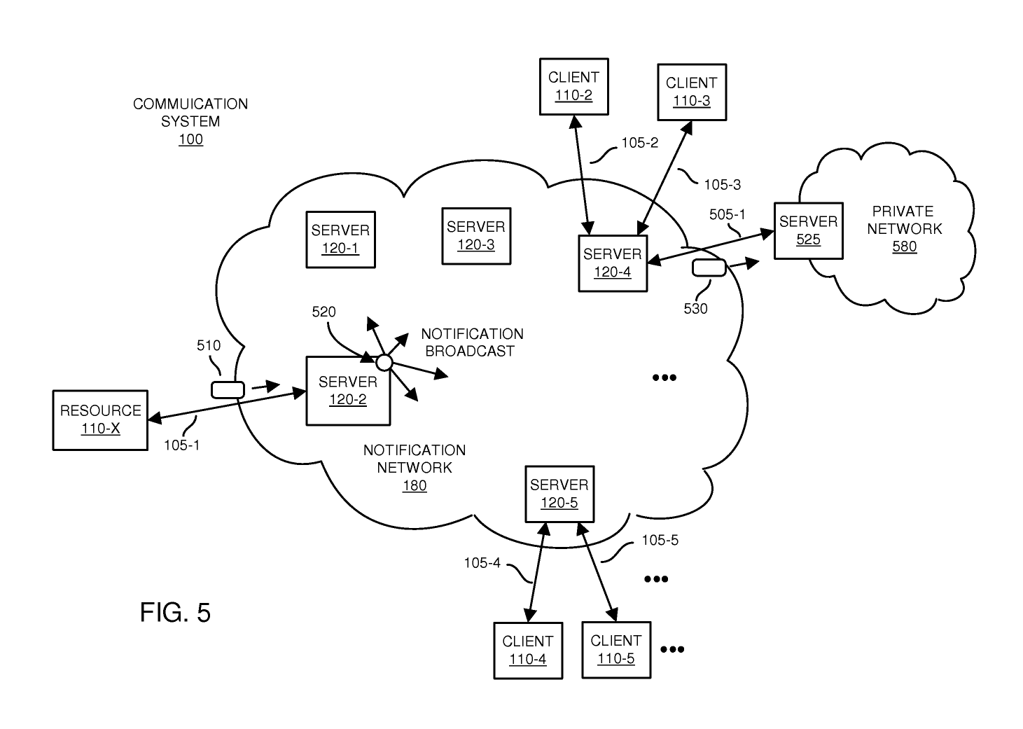

FIG. 5 is an example diagram illustrating a corporate server as a participant of a communication session according to embodiments herein.

As shown, the server 525 can be a client participating in a communication session. In such an embodiment, the server 525 (e.g., external to notification network 180) contacts the server 120-4 (similar to a manner in which a client joins a communication session as discussed above) to be a participant in the communication session ABC. The server 120-4 in the notification network 180 registers the corporate server 525 as a participant to the communication session ABC. The server 120-4 communicates with the corporate server 525 via a dedicated communication link 505-1.

In a similar manner as discussed herein for clients participating in communication session ABC, the corporate server 525 receives broadcasted notification of one or more messages 510 posted by other participants to the communication session ABC. As an example, assume that resource 110-X posts message 510 to communication session ABC. In this instance, the server 120-2 generates notification 520 about message 510 and broadcasts the notification to other servers in notification network 180. Server 120-4 receives the notification 520 and, based on registry information indicating that the server is a participant in the communication session ABC, forwards appropriate information regarding the message 410 to server 525.

In a reverse direction and similar manner as previously discussed, the corporate server 525 can post messages to other participants in the communication session ABC via posting of messages to sever 120-4. For example, server 525 can forward messages received from any of one or more processes executed in private network 580 to communication session ABC. Server 120-4 forwards the messages via broadcast notifications to other participants in the communication session.

Note again that forwarding contents and/or providing notification of messages from a server to a corresponding client can be conditional. For example, as previously discussed, a respective client operating an application can register with a server to become a participant in a communication session. The client or other source can provide forwarding or handling rules indicating how to handle distribution of messages and/or respective content to other members in the network. Thus, the registering server can receive rules indicating conditions in which the registering server will forward messages and/or notifications to the respective client.

In one embodiment, the different clients or server 525 can provide configuration setting information indicating what types of messages or content posted by other clients to the communication session will be forwarded to the respective client when detected by the registering server. Accordingly, the servers in notification network 180 can control or filter which messages are forwarded to the respective client in accordance with configuration settings provided by the respective client or other source.

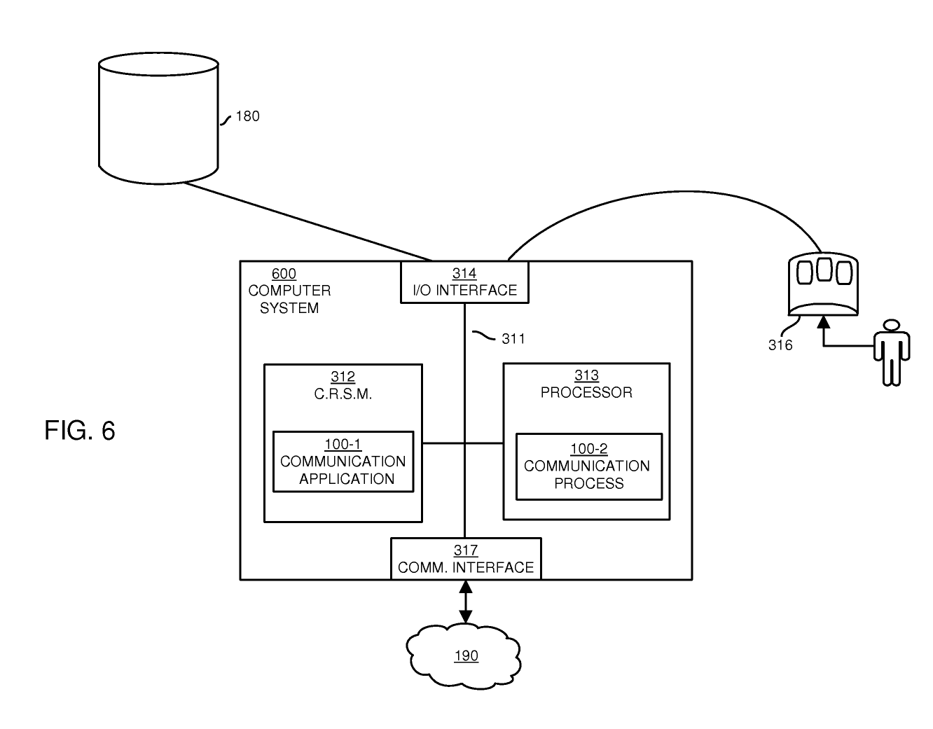

FIG. 6 is an example block diagram of a computer system for implementing a method of communicating messages according to embodiments herein.

Computer system 600 can include one or more computerized devices such as a personal computer, workstation, portable computing device, console, network terminal, processing device, network device, etc., operating as a server, client, etc.

Note that the following discussion provides a basic embodiment indicating how to execute functionality according to embodiments herein. However, it should be noted that the actual configuration for carrying out the operations as described herein can vary depending on a respective application.

As shown, computer system 600 of the present example includes an interconnect 311 that couples computer readable storage media 312 such as a non-transitory type of computer readable storage media in which digital information can be stored and retrieved, a processor device 313, I/O interface 314, and a communications interface 317.

I/O interface 314 provides connectivity to repository 180 and, if present, other devices such as display screen, peripheral devices 316, keyboard, computer mouse, etc.

Computer readable storage medium 312 can be any suitable device such as memory, optical storage, hard drive, floppy disk, etc. In one embodiment, the computer readable storage medium 312 is a non-transitory computer readable storage media (e.g., any hardware storage media) to store instructions and/or data.

Communications interface 317 enables the computer system 600 and processor device 313 to communicate over a network 190 to retrieve information from remote sources and communicate with other computers. I/O interface 314 enables processor device 313 to retrieve respective information from repository 180.

As shown, computer readable storage media 312 can be encoded with communication application 100-1 (e.g., software, firmware, etc.) executed by processor 313.

During operation of one embodiment, processor 313 accesses computer readable storage media 312 via the use of interconnect 311 in order to launch, run, execute, interpret or otherwise perform the instructions of communication application 100-1 stored on computer readable storage medium 312. Communication application 100-1 can include appropriate instructions, logic, etc., to carry out any or all functionality associated with the resources (e.g., clients, servers, notification network, etc.) in communication system 100 as discussed herein.

Execution of the communication application 100-1 produces processing functionality such as communication process 100-2 in processor 313. In other words, the communication process 100-2 associated with processor device 313 represents one or more aspects of executing communication application 100-1 within or upon the processor device 313 in the computer system 600.

Those skilled in the art will understand that the computer system 600 can include other processes and/or software and hardware components, such as an operating system that controls allocation and use of hardware resources to execute communication application 100-1.

In accordance with different embodiments, note that computer system may be any of various types of devices, including, but not limited to, a personal computer system, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, or in general any type of computing or electronic device.

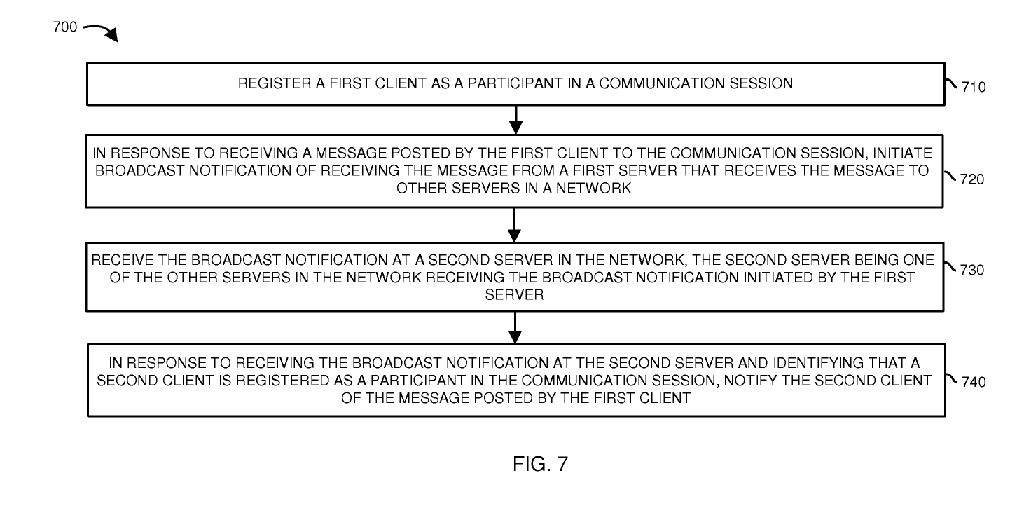

Functionality supported by resources in communication system 100 will now be discussed via flowcharts in FIGS. 7-9. Note that there will be some overlap with respect to concepts discussed above for FIGS. 1 through 6. Also, note that the steps in the below flowcharts need not always be executed in the order shown. That is, the steps can be executed in any suitable order.

FIG. 7 is a flowchart 700 illustrating a general technique of supporting communications using a broadcast network according to embodiments herein.

In step 710, the server 120-2 registers client 110-1 as a participant in a communication session ABC.

In step 720, in response to receiving a message 310 posted by the client 110-1 to the communication session ABC, the server 120-2 initiates broadcast notification 320 of receiving the message 310 from server 120-2 that receives the message 310 to other servers in the notification network 180.

In step 730, the server 120-4 receives the broadcast notification 320. The server 120-4 is one of multiple other servers in the notification network 180 that receives the broadcast notification 320 initiated by server 120-2.

In step 740, in response to receiving the broadcast notification 320 at the server 120-4 and identifying that client 110-2 is registered as a participant in the communication session ABC to which the message is directed, the server 120-4 notifies the client 110-2 of the message 310 posted by client 110-1.

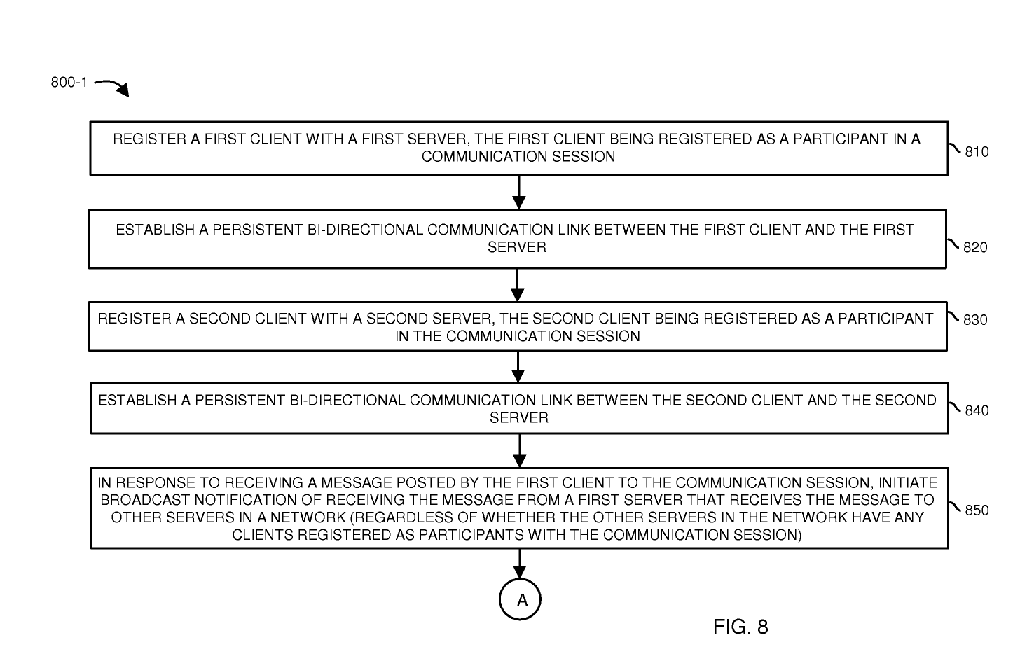

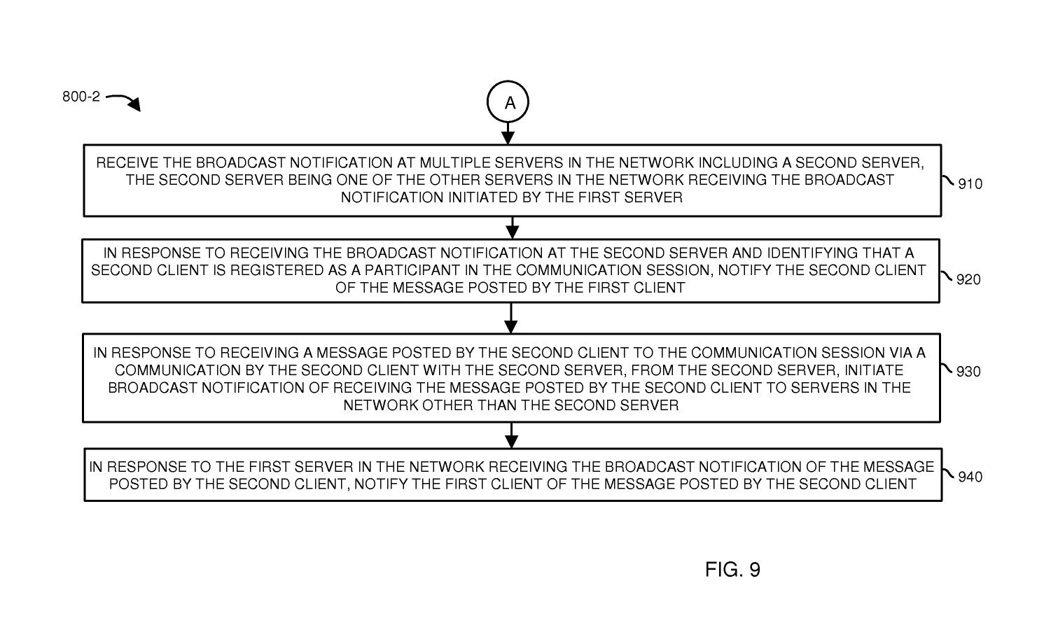

FIGS. 8 and 9 combine to form a flowchart 800 (e.g., flowchart 800-1 and flowchart 800-2) illustrating a more detailed method of communicating messages in a communication system according to embodiments herein.

In step 810, the server 120-2 registers client 110-1 as a participant of communication session ABC.

In step 820, the server 120-2 and/or client 110-1 establishes a persistent bi-directional communication link 105-1 between the client 110-1 and the server 120-2.

In step 830, the server 120-4 registers client 110-2 as participant of communication session ABC.

In step 840, the server 120-2 and/or client 110-2 establishes a persistent bi-directional communication link 105-2 between the client 110-2 and the server 120-2.

In step 850, in response to receiving a message 310 posted by the client 110-1 to the communication session ABC, the server 120-2 initiates broadcast notification of receiving the message 310 to other servers in notification network 180. The notification 320 can be broadcasted to other servers regardless of whether the other servers in the network have any clients registered as participants with the communication session ABC.

In step 910 of flowchart 800-2 (FIG. 9), the server 120-2 receives the broadcast notification 320.

In step 920, in response to receiving the broadcast notification 320 at the server 120-4 and identifying that client 110-2 is registered as a participant in the communication session ABC, the server 120-4 notifies the client 110-2 of the message 310 posted by the client 110-1.

In step 930, in response to receiving a message posted by the client 110-2 to the communication session ABC, the server 120-2 initiates broadcast notification of receiving the message posted by the client 110-2 to other servers in the notification network 180.

In step 940, in response to the server 120-2 in the notification network 180 receiving the broadcast notification of the message posted by the client 110-2, the server 120-2 notifies the client 110-1 of the message posted by the client 110-2.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
registering a first client as a participant in a communication session;
in response to receiving a message posted by the first client to the communication session, initiating broadcast notification of receiving the message from a first server that receives the message to other servers in a network;
receiving the broadcast notification at a second server in the network, the second server being one of the other servers in the network receiving the broadcast notification initiated by the first server; and
in response to receiving the broadcast notification at the second server and identifying that a second client is registered as a participant in the communication session, notifying the second client of the message posted by the first client.

2. The method as in claim 1, wherein initiating broadcast notification of receiving the message from the first server to other servers in the network includes:
initiating transmission of the broadcast notification to a respective server in the network regardless of whether the respective server in the network has any clients registered with the communication session.

3. The method as in claim 1, wherein registering the first client includes registering the first client with the first server;
and wherein registering the first client occurs at least in part in response to the first client executing an application to which the communication session pertains, the first client being a mobile device.

4. The method as in claim 1, wherein registering the first client as a participant includes establishing a persistent bi-directional communication link between the first client and the first server.

5. The method as in claim 4 further comprising:
registering the second client as a participant in the communication session; and
wherein registering the second client includes establishing a persistent bi-directional communication link between the second client and the second server.

6. The method as in claim 1, wherein initiating broadcast notification of receiving the message further comprises:
initiating transmission of the broadcast notification to each respective server that is part of the network regardless of whether the respective server has any clients registered to participate in the communication session.

7. The method as in claim 1 further comprising:
in response to receiving a message posted by the second client to the communication session via a communication with the second server, from the second server, initiating broadcast notification of receiving the message posted by the second client to servers in the network other than the second server;
in response to the first server in the network receiving the broadcast notification of the message posted by the second client, notifying the first client of the message posted by the second client.

8. The method as in claim 7, wherein each of the first client and the second client are mobile devices executing a particular application, the particular application enabling registration with a server in the network to participate in the communication session.

9. The method as in claim 1, wherein the second client is a corporate server.

10. The method as in claim 1 further comprising:
in response to detecting that a number of clients registering to participate in the communication session exceeds a threshold value, assigning additional servers to the network to receive broadcast type messages and support communications with additional participants of the communication session.

11. A method comprising:
at a first server in a network in which servers communicate via transmission of broadcast-type messages, receiving a message from a first client over a communication link between the first client and the first server;
in response to receiving the message at the first server, initiating broadcast of the message from the first server to other servers in the network;
receiving the broadcasted message at a second server in the network, the second server being one of the other servers receiving the broadcasted message; and
from the second server, notifying a second client of the broadcasted message over a communication link between the second server and the second client.

12. The method as in claim 11, wherein notifying the second client occurs in response to detecting that the second client is registered with the second server to receive broadcast messages associated with a particular communication session to which the first client is also registered as a member.

13. The method as in claim 11, wherein receiving and notifying comprises:
subsequent to receiving the broadcasted message, processing the broadcasted message at the second server to identify a type of application executed by the first client that generated and transmitted the message to the first server; and
in response to detecting that the second client is registered with the second server to receive messages from clients executing the type of application executed by the first client, initiating transmission of the broadcasted message from the second server to the second client.

14. The method as in claim 11 further comprising:
in response to detecting that a third client is not registered with the second server to receive messages from clients executing the type of application executed by the first client, preventing transmission of the broadcasted message from the second server to the third client.

15. The method as in claim 12 further comprising:
establishing the communication link between the first client and the first server to be a persistent bi-directional communication link in which to communicate with other clients executing the type of application executed by the first client; and
establishing the communication link between the second client and the second server to be a persistent bi-directional communication link in which to communicate with other clients executing the type of application.

16. The method as in claim 15, wherein the first persistent bi-directional link is an encrypted connection using web-based sockets supporting communication with the first server; and
wherein the second persistent bi-directional link is an encrypted connection using web-based sockets supporting communication with the second server.

17. The method as in claim 11 further comprising:
receiving a request from the first client to participate in a communication session with other clients executing a particular application; and
in response to receiving the request, establishing the communication link between the first client and the first server.

18. The method as in claim 11, wherein receiving and notifying comprises:
subsequent to receiving the broadcasted message, processing the broadcasted message at the second server to identify a communication session to which the message generated by the first client is directed;
in response to detecting that the second client is registered with the second server to receive messages associated with the communication session indicated by the broadcast message, initiating transmission of the message from the second server to the second client in accordance with the forwarding rules provided by the second client.

19. A system comprising:
a network including at least a first server and a second server, each of the servers in the network communicating with each other via transmission of broadcast-type messages;
a first client in communication with the first server, the first server in the network receiving a message from the first client over a communication link between the first client and the first server, the first server initiating broadcast of the message from the first server to multiple other servers in the network in response to receiving the message; and
a second client in communication with the second server, the second server receiving the broadcasted message, the second server being one of the multiple other servers in the network receiving the broadcasted message, the second server notifying the second client of the broadcasted message over a communication link between the second server and the second client.

20. The system as in claim 19, wherein the broadcasted message includes an identifier value indicating a communication session to which the message is directed.

21. A computer-readable hardware storage medium having instructions stored thereon for processing data information, such that the instructions, when carried out by a processing device, cause the processing device to perform operations of:
registering a first client as a participant in a communication session;
in response to receiving a message posted by the first client to the communication session, initiating broadcast notification of receiving the message from a first server that receives the message to other servers in a network;
receiving the broadcast notification at a second server in the network, the second server being one of the other servers in the network receiving the broadcast notification initiated by the first server; and
in response to receiving the broadcast notification at the second server and identifying that a second client is registered as a participant in the communication session, notifying the second client of the message posted by the first client.

22. A computer system comprising:
a processor;
a memory unit that stores instructions associated with an application executed by the processor; and
an interconnect coupling the processor and the memory unit, the interconnect enabling the computer system to execute the application and perform operations of:
registering a first client as a participant in a communication session;
in response to receiving a message posted by the first client to the communication session, initiating broadcast notification of receiving the message from a first server that receives the message to other servers in a network;
receiving the broadcast notification at a second server in the network, the second server being one of the other servers in the network receiving the broadcast notification initiated by the first server; and
in response to receiving the broadcast notification at the second server and identifying that a second client is registered as a participant in the communication session, notifying the second client of the message posted by the first client.
